(19) United States
(12) Patent Application Publication
(10) Pub. No.: US 2015/0066755 A1
(43) Pub. Date: Mar. 5, 2015

(54) Resolution System Linking, Matching, Transferring, Paying and Netting Obligations

(71) Applicant: Samer ElBizri, Santa Monica, CA (US)

(72) Inventor: Samer ElBizri, Santa Monica, CA (US)

(21) Appl. No.: 14/474,165

(22) Filed: Aug. 31, 2014

Related U.S. Application Data
(60) Provisional application No. 61/872,823, filed on Sep. 2, 2013.

(51) Int. Cl. G06Q 20/14; G06Q 20/26

(52) U.S. Cl. CPC G06Q 20/14; G06Q 20/26
USPC 705/40

(57) ABSTRACT

An economic value exchange and invoice resolution system is described that includes: at least one sales invoice, wherein each sales invoice comprises a credit value, at least one purchase invoice, wherein each purchase invoice comprises a debit value, at least one database or repository stored on a medium for executing the executable code that collects the information for the at least one sales invoice and the at least one purchase invoice. An economic value exchange and resolution system is disclosed that includes: at least one sales invoice, wherein each sales invoice comprises a credit value, at least one purchase invoice, wherein each purchase invoice comprises a debit value, at least one database or repository stored on a medium for executing the executable code that collects the information for the at least one sales invoice and the at least one purchase invoice; and an executable code for intelligently determining an invoice chain comprising at least one purchase invoice having a debit value and at least one sales invoice having a credit value and offsetting the debit value with the credit value to form an offset value.

This U.S. Utility Application claims priority to U.S. Provisional Application Ser. No. 61/872,823 filed on Sep. 2, 2013, which is commonly-owned and incorporated herein in its entirety by reference.

### BACKGROUND

Access to efficient financing for small and medium size businesses and consumers is an extremely rare process since the introduction of commercial and consumer lending. Although small and medium size companies represent half of the business economy, they have limited and often overpriced access to liquidity. Today, four banks control most of the deposits and loan portfolios in the United States. Limited competition allowed the banks to maximize margins on their loans by 1) focusing on higher creditworthy borrowers, which reduces their risk and the interest they pay to their depositors and creditors, and 2) increasing the amounts they charge on these loans much higher than capital markets' pricing. This made lending to small and less creditworthy businesses uncompetitive, since any increase in lending risk increases the bank's interest costs and any further increase in charges on already overpriced loans is likely to increase loan defaults. Smaller lenders cannot fill the gap. Their inability to diversify with higher creditworthy loans dramatically increases their risk and funding costs. With the shape and structure of credit and bank consolidation, there is a significant need for a liquidity solution in the market that also gives an opportunity for liquidity providers beyond what is available today.

Consumers suffer from a similar lack of access to efficient amount and cost of liquidity. For example, although a consumer can save on interest in some cases by paying a monthly mortgage payment on a bi-weekly basis, any form of credit he or she obtains would outweigh the savings. Payments on credit cards and interest charges are always very high and an alternative short-term access to liquidity could be of significant benefit to consumers.

On the other hand depositors and investors lack good access to low risk investments that pays a good return in comparison to risk and liquidity. For example, money market returns are always close to inflation and for many years significantly below inflation. Savings accounts are similar in return and any alternative either significantly increases illiquidity (CDs, annuities, real estate, etc. . . . ) or significantly increases risk (longer termed bonds, high yield securities, preferred stock, etc. . . . ).

Therefore, it would be ideal to address a significant portion of the mentioned problems in a very efficient manner. There is no solution in existence today that provides solutions or is comparable in efficiency and economic benefit to the solutions from this new invention.

### SUMMARY OF THE SUBJECT MATTER

An invoice resolution system is disclosed that includes: at least one sales invoice, wherein each sales invoice comprises a credit value, at least one purchase invoice, wherein each purchase invoice comprises a debit value, at least one database or repository stored on a medium for executing the executable code that collects the information for the at least one sales invoice and the at least one purchase invoice; and an executable code for intelligently determining an invoice Chain comprising at least one purchase invoice having a debit value and at least one sales invoice having a credit value and offsetting the debit value with the credit value to form an offset value.

Another invoice resolution system is disclosed that includes: at least one sales invoice, wherein each sales invoice comprises a credit value, at least one purchase invoice, wherein each purchase invoice comprises a debit value, at least one database stored on a network computer system that collects the at least one sales invoice and the at least one purchase invoice; and an executable code for intelligently sorting the at least one purchase invoice having a debit value and at least one sales invoice having a credit value to produce an invoice Chain and offsetting the debit value with the credit value.

A method for resolving invoice obligations is described and includes: providing at least one seller having at least one sales invoice, providing at least one customer having at least one sales invoice and at least one purchase invoice, producing an invoice chain by utilizing the at least one sales invoice and at least one of the at least one purchase invoice; and offsetting the at least one sales invoice of the seller with at least one sales invoice of the customer, at least one purchase invoice or a combination thereof to produce an offset value.

An economic value exchange and invoice resolution system is described that includes: at least one sales invoice, wherein each sales invoice comprises a credit value, at least one purchase invoice, wherein each purchase invoice comprises a debit value, at least one database or repository stored on a medium for executing the executable code that collects the information for the at least one sales invoice and the at least one purchase invoice.

An economic value exchange and resolution system is disclosed that includes: at least one sales invoice, wherein each sales invoice comprises a credit value, at least one purchase invoice, wherein each purchase invoice comprises a debit value, at least one database or repository stored on a medium for executing the executable code that collects the information for the at least one sales invoice and the at least one purchase invoice; and an executable code for intelligently determining an invoice Chain comprising at least one purchase invoice having a debit value and at least one sales invoice having a credit value and offsetting the debit value with the credit value to form an offset value.

### BRIEF DESCRIPTION OF THE FIGURES

FIG. 1 describes the basic structure of a Chain, providing at least one Party 10 having at least one sales invoice 11, providing at least one customer 20 having at least one sales invoice 21 and at least one purchase invoice 22, producing an invoice Chain by utilizing the at least one sales invoice 21 and at least one of the at least one purchase invoice 22; and (1) offsetting the at least one sales invoice of the seller 31 with at least one sales invoice of the customer 21, at least one purchase invoice 22 or a combination thereof.

FIG. 2 shows a contemplated embodiment, wherein System 101 comprises or, in the alternative, consists of a network of connections between Parties based on their obligations to pay each other any amounts at any time.

FIG. 3a shows an invoice Chain as described in FIG. 1, with the addition of an Agent 150.

FIG. 3b is a continuation of FIG. 3a and a combination of Chains similar to FIG. 1 and FIG. 3a using an Agent 300 to facilitate the direct or indirect combination of separate Chains.

### DETAILED DESCRIPTION

A new system and related methods have been produced to enable a seller of services or products to use the economic value of the service or product, provided or sold, or to be provided or sold, to satisfy debt obligations on product, services or taxes owed, or receive early cash on that economic value.

An invoice resolution system is disclosed that includes: at least one sales invoice, wherein each sales invoice comprises a credit value, at least one purchase invoice, wherein each purchase invoice comprises a debit value, at least one database or repository stored on a medium for executing the executable code that collects the information for the at least one sales invoice and the at least one purchase invoice; and an executable code for intelligently determining an invoice Chain comprising at least one purchase invoice having a debit value and at least one sales invoice having a credit value and offsetting the debit value with the credit value to form an offset value.

Another invoice resolution system is disclosed that includes: at least one sales invoice, wherein each sales invoice comprises a credit value, at least one purchase invoice, wherein each purchase invoice comprises a debit value, at least one database stored on a network computer system that collects the at least one sales invoice and the at least one purchase invoice; and an executable code for intelligently sorting the at least one purchase invoice having a debit value and at least one sales invoice having a credit value to produce an invoice Chain and offsetting the debit value with the credit value.

A method for resolving invoice obligations is described and includes: providing at least one seller having at least one sales invoice, providing at least one customer having at least one sales invoice and at least one purchase invoice, producing an invoice chain by utilizing the at least one sales invoice and at least one of the at least one purchase invoice; and offsetting the at least one sales invoice of the seller with at least one sales invoice of the customer, at least one purchase invoice or a combination thereof to produce an offset value.

An economic value exchange and invoice resolution system is described that includes: at least one sales invoice, wherein each sales invoice comprises a credit value, at least one purchase invoice, wherein each purchase invoice comprises a debit value, at least one database or repository stored on a medium for executing the executable code that collects the information for the at least one sales invoice and the at least one purchase invoice.

An economic value exchange and resolution system is disclosed that includes: at least one sales invoice, wherein each sales invoice comprises a credit value, at least one purchase invoice, wherein each purchase invoice comprises a debit value, at least one database or repository stored on a medium for executing the executable code that collects the information for the at least one sales invoice and the at least one purchase invoice; and an executable code for intelligently determining an invoice Chain comprising at least one purchase invoice having a debit value and at least one sales invoice having a credit value and offsetting the debit value with the credit value to form an offset value.

Resolution systems are disclosed that include: at least one sales invoice, wherein each sales invoice comprises a credit value, at least one purchase invoice, wherein each purchase invoice comprises a debit value, at least one database or repository stored on a medium for executing the executable code that collects the at least one sales invoice and the at least one purchase invoice; and an executable code for intelligently determining an invoice chain comprising at least one purchase invoice having a debit value and at least one sales invoice having a credit value and offsetting the debit value with the credit value.

Invoice resolution systems are also disclosed that include: at least one sales invoice, wherein each sales invoice comprises a credit value, at least one purchase invoice, wherein each purchase invoice comprises a debit value, at least one database or repository stored on a network computer system that collects the at least one sales invoice and the at least one purchase invoice; and an executable code for intelligently sorting the at least one purchase invoice having a debit value and at least one sales invoice having a credit value to produce an invoice chain and offsetting the debit value with the credit value.

Methods for resolving invoice obligations include: providing at least one seller having at least one sales invoice, providing at least one customer having at least one sales invoice and at least one purchase invoice, producing an invoice chain by utilizing the at least one sales invoice and at least one of the at least one purchase invoice; and (1) offsetting the at least one sales invoice of the seller with at least one sales invoice of the customer, at least one purchase invoice or a combination thereof; (2) exchanging, transferring or assigning value or rights in whole or in part of one sales invoice of a seller, with another sales invoice of another seller and offsetting the at least one sales invoice of that seller with at least one sales invoice of that seller's customer; or (3) transferring or selling the economic value and or rights of at least one sales invoice of the seller to a third Party, which pays the obligation of the seller on the customer sales invoice.

A party, seller or customer, as used herein, means or can be a business; institution; organization; employee; contractor; non-profit, public or government entity; any natural person or legal entity with rights and obligations to receive and make payments; or any combination thereof. Sales invoice, as used herein, means any right of a Party to receive payment for any purpose from another Party (example a receivable, paycheck, etc.); Purchase invoice, as used herein, means any obligation of a Party to pay another Party (example, a bill, a tax, an IOU, a bond etc. . . . ) and invoice alone, as used herein, means either Sales invoice or Purchase invoice. Network computer, as used herein, means any computing device that can communicate data to another device directly or over a network of any sort, examples such as a computer over the Internet or a tablet over a mobile or local network. Database or repository, as used herein, means any method on a device that holds data.

Contemplated embodiments transform papers invoicing and physical cash transactions into electronic transactions and to allow access to liquidity for Parties owed an obligation prior to the obligation becoming due; to maximize the available liquidity to such Parties; to provide such liquidity without conventional methods of debt obligation; to provide economic incentives without credit risk to liquidity providers; to provide Agents as intermediaries of risk to expedite transactions; to provide economic value to Parties making payments on obligations in the regular course of business; and to minimize the efforts, actions and or cost of liquidity, maximize economic return on providing liquidity; minimize or eliminate credit risk from providing liquidity; and provide a system and method to achieve all the above that is not available and without which there is no efficient manner of achieving the purposes of the invention. The invention provides economic benefits that no existing alternative system or method can provide.

The result from the implementation of contemplated embodiments disclosed herein is to significantly increase access to investment returns while significantly reducing or eliminating risk; significantly increasing access to liquidity while reducing cost and maximizing efficiency and benefits.

Contemplated embodiments transform paper invoicing and physical cash into electronic transactions. Disclosed and contemplated embodiments use information from the sales invoices to link sellers and customers together into Chains of invoice credits and debits. These Chains can be organized in multiple fashions to allow the flow of a one-dollar payment at the beginning of the Chain to clear several dollars through the Chain. This is the result of netting the sales invoices of each seller with the sales invoices of each customer sequential or simultaneously in the Chain. Allowing one-dollar to clear multiple dollars of obligations. Multiple Chains of different sellers and customers can be linked through a third Party, transferring and/or purchasing the at least one sales invoice of the seller in one Chain, paying or netting the obligation of that seller on the customer sales invoice in that Chain; and if desired, using the proceeds when the purchased sales invoice of the seller is received or is part of the third Party Chain, using its value to pay or net the third Party's obligation in a new Chain. A Chain may consist of only one seller and one customer, or multiple sellers and customers.

One contemplated system and method involves the use of an intermediary agent to form and transact in invoice Chains. The agent (“Agent”) can be an automated matching system or a third Party that intermediates transactions between the Parties of a Chain. The Agent may also be a third Party that purchases, sells, assigns, transfers, transmits, control and/or act on behalf of other third Parties to pay, net, match, fulfill any obligation to a financial transaction or right to receive monetary value in the form of connecting third Parties together and providing non-cash methods in fulfilling such obligations, payments, credits or debits.

Another contemplated system and method comprises a computing system to which obligation and credit data is connected, uploaded, entered manually or integrated in any form usable by a computing system. The computing system will then use the information from these obligation and credit data to find statistical, cash flow, trade and other relationships that result in forming credit and debit Chain between two or more Parties, especially between multiple Parties in which one payment or equivalent of a credit value can net several other obligations belonging to several Parties as credit and debit counterparts within this Chain.

Another contemplated system and method comprises a computing system to obligation and credit data is connected, uploaded, entered manually or integrated in any form usable by a computing system. The computing system will then use the information from these obligation and credit data to form statistical, cash flow, trade and other relationships that result in forming credit and debit Chain between two or more Parties, even if there is no linear relationship linking the two or more Parties together in any normal flow of payment, credit or debit, as per the previously described system and method above.

Another contemplated method comprises a computing system to obligation and credit data is connected, uploaded, entered manually or integrated in any form usable by a computing system. The computing system will then use the information from these obligation and credit data to form statistical, cash flow, trade and other relationships that result in forming credit and debit Chain between two or more Parties, even if there is no linear relationship linking the two or more Parties together in any normal flow of payment, credit or debit, as per the previously described system and method above. Whereas, the system and method of the Agent can offer specific economic value for a credit or debit obligation to one Party to participate in a transaction that can only be available through the Agent since no such economic value can be obtained from an unrelated Party without the Agent. The unrelated Party is a Party that is not a direct creditor or debtor of another Party, which is offered an economic value related to an economic value of that unrelated Party.

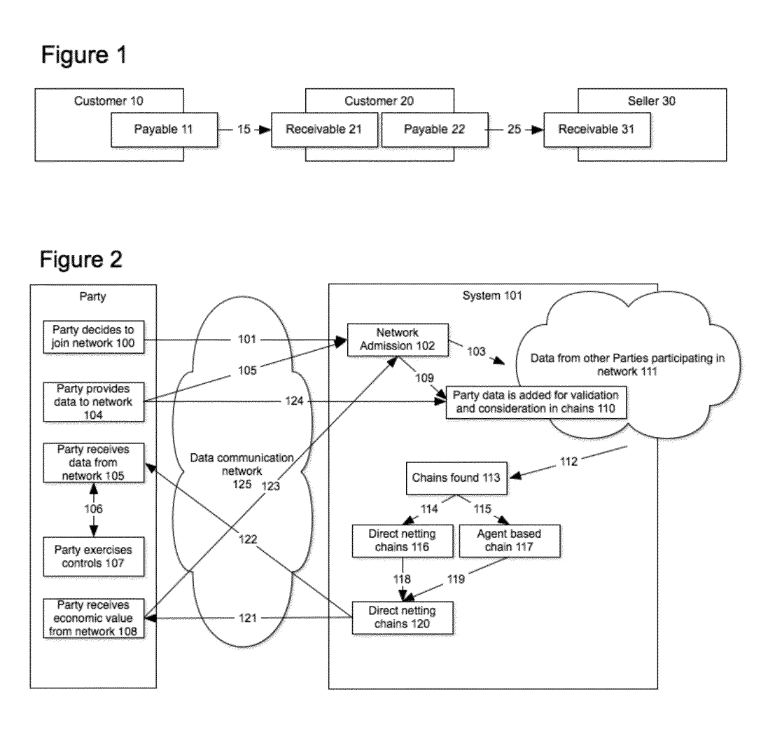

FIG. 1 describes the basic structure of a Chain, providing at least one Party 10 having at least one sales invoice 11, providing at least one customer 20 having at least one sales invoice 21 and at least one purchase invoice 22, producing an invoice Chain by utilizing the at least one sales invoice 21 and at least one of the at least one purchase invoice 22; and (1) offsetting the at least one sales invoice of the seller 31 with at least one sales invoice of the customer 21, at least one purchase invoice 22 or a combination thereof.

One contemplated embodiment is to use a cash payment 15 by a customer 10 on its purchase invoice 11 to pay purchase invoice 22 of customer 20 directly without the need for the cash on purchase invoice 11 to be sent to customer 20 first and then for customer 20 to pay seller 30 on it's sales invoice 31. The process allow purchase invoice 22 to be netted and offset by sales invoice 21. It also allows seller 30 to receive cash without customer 20 using cash from its deposit account. Assuming all amounts are equal and any partial amounts are made whole by other sales invoices with credit or cash from deposits or credit of the customer offsetting or making payment.

Sellers and customers of an invoice Chain are Parties as described above in the description section. An invoice Chain comprises any form of debt or debit owed for any purpose and any credit to be received for any purpose, including but not limited to, businesses doing business together or an employee owed hours of work using their economic value to make a mortgage payment. A Chain can include any number of Parties and branch into any number of Chains. In virtually every Chain, there are economic incentives exchanged between liquidity providers (such as payers using cash or the value of a receivable to pay or net the full or partial value of a payable) and liquidity seekers (such as Parties getting paid early on a receivable or receiving Agent or other financing). The economic incentives are communicated to Parties in the Chain ahead of a transaction of payment or netting taking place. These economic incentives can vary in amounts, forms and based on Business Rules.

FIG. 2 shows a contemplated embodiment, wherein System 101 comprises or, in the alternative, consists of a network of connections between Parties based on their obligations to pay each other any amounts at any time. The network is controlled and managed by centralized and decentralized computing devices running a software code and either directly or indirectly managing the processes of the invention. A contemplated system 101 allows participants to communicate with it through computer code or other means translated into computer code through manual or other input. Once a Party 100 decides to join the network, it can communicate through several means/methods 101 and be qualified to join based on a set of business rules, for example, providing identification information.

The Network Admission System 102 then approves the Party 100 to join or rejects it, with option to do so automatically or manually by one or more operators. The Network Admission System 102 also manages and organizes access to the System 101 for each User (i.e., a Party 100 interacting with a contemplated system 101). The Network Admission System 102 can run certain checks including relationships of the Party 100 joining or accessing the System 101 with other Parties, the data cloud 111, and its data in the network. Any new or changed data is processed and updates data in the data 111 to be considered for processing 112 by the System 101. The data cloud 111 comprises of centralized and decentralized databases, including, but not limited to, P2P in a form of grid computing and/or on System 101 computing devices, for example servers or specialized devices.

The data received 109 or pulled 109 from the Party 100 is then reviewed and validated 110 automatically and/or manually for authenticity, accuracy and other business rules in order to be usable by a contemplated system 101 for matching, obligation netting, credit and debit and payment transactions. Once usable data 110, then it is considered along with the rest of the data in the Data Cloud 111 for netting and payments subject to business rules. The netting and payment process 112 find relationships between Parties and their obligations through their invoices, billing, loan obligations or other forms of payment or debt obligation or credit. These relationships form Chains 113 of credit and debit obligations connections and flow of economic value between the Parties.

A contemplated system 101 finds and forms these Chains using heuristics based on Business Rules, Business Rules are controls to manage the activities of the System 101, for example, apply or waive a penalty on an overdue bill or interest rate cannot be below LIBOR. Each Chain at the time of processing 113 or post processing 113 would have economic value applied to each obligation or credit within it, such as a discount or premium, interest payment or receipt, fees or other forms of economic value in addition or subtraction to the obligation amount. This added or subtracted economic value is used to compensate liquidity providers and as a cost to liquidity recipients in the System 101. Liquidity providers, recipients and added/subtracted economic value of the total obligation or credit amounts are all determined based on Business Rules.

A contemplated system 101 based on forming and sorting Chain based on Business Rules in process 113, can determine automatically and/or manually whether to not include 114 or to include 115 an Agent 117 in processing the obligations and credit payments in the Chain. An Agent 117 is a third Party that can purchase, assign, be assigned, credit and debit obligations, such as a company factoring an invoice.

A contemplated system 101 will act as netting and clearing system, thus allowing transactions to occur in the Chains by using credit one obligation, including but not limited to, an invoice receivable or money owed on work hours for an employee to be used instead of cash or electronic cash transfer to make a payment and fulfill an obligation to another Party, such as paying a bill or a tax.

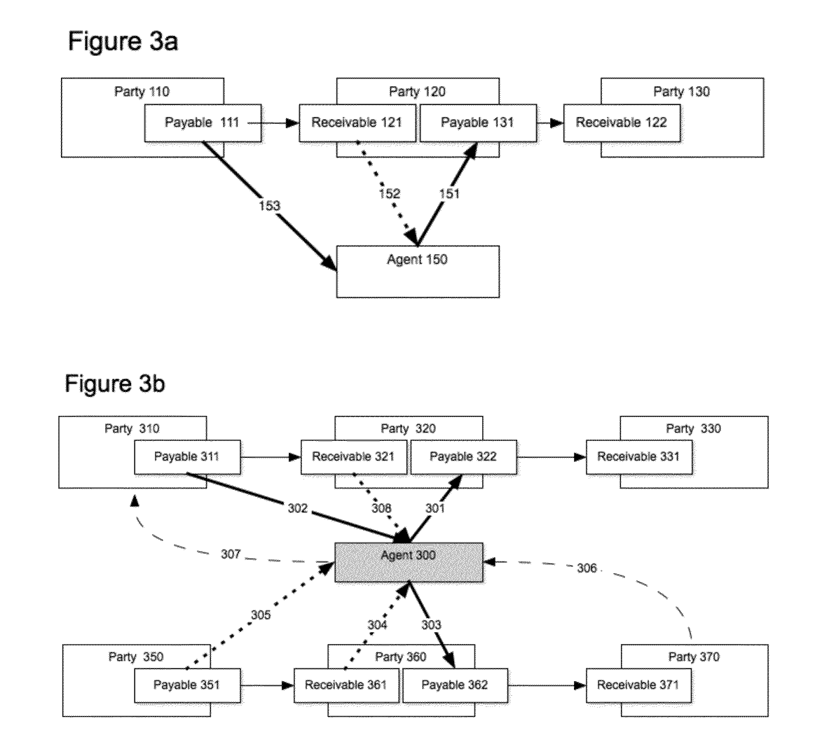

A contemplated system 101 can clear a Chain of obligations and credit by several methods, including but not limited to, (1) using cash payments made by one or more Parties in a Chain to fulfill the liquidity need of one or more Parties at the end of the Chain; (2) providing a Party or Parties at the beginning of Chain with economic incentives, such as a discount or interest income, to make a cash payment on an obligation in the Chain which can be used to clear a Chain as in (1) above; (3) netting obligations and credit of the Party(ies) in between the first Party(ies) in the Chain and the recipient(s) of liquidity at the end of a Chain(s), such as the Chain in (1) or (2) above; (4) using cash and netting to fulfill obligations and credit of the Party(ies) in between the first Party(ies) in the Chain and the recipient(s) of liquidity at the end of a Chain(s), such as the Chain in (3) above; (5) using an Agent as an intermediary to link two or more separate Chains, by assigning credit, selling credit and/or making payment on obligations as described in FIG. 3; (6) a combination of all of the methods above.

A contemplated system 101 performs the methods based on Business Rules and optimization of balancing or favoring liquidity and other economic incentives, automatically and/or manually. Once the Chains to be netted and paid are decided 120, all fees and economic incentives are added and deducted and the Chains are cleared 120 and any netted values and cash payments are completed 120 and reports to Party 122 as well as cash and incentives provided to Party 121. The Party 100 receives the economic value for the Chains on its obligations and other Party(ies) obligation(s) to it. The change in any data of the Party 100 related to the System 101 is then shared 123, as will as any User control decisions and data is communicated 124 to the System 101.

All communication between the Party 100 and a contemplated system 101 occurs through the Data Communication Network 125 representing existing data, voice, transportation or mail networks in existence or in future development, including internet protocols, mobile wireless or postal systems among others. All computing devices, including but not limited to, servers and other system used by the System 101 shall include existing computer system, such as servers, pc, mac, tablets, phones, etc and future systems that replace them for data communication and processing.

FIG. 3a shows an invoice Chain as described in FIG. 1, with the addition of an Agent 150 (Agent described in the Description section above). The Agent 150 can act as a facilitator in initiating and/or completing a Chain or increasing the economic value and/or incentives in a Chain when needed or desired. Some methods involving the Agent 150 in a Chain of the invention are: (1) the Agent 150 can replace a payment 111 to be made by Party 110 in order to initiate the Chain of Parties 110 through 130 (111 to 122). The Agent 150 can do so by (a) purchasing, factoring or (b) lending against the sales receivable 121 of Party 120; (c) lending secured by other assets or unsecured; or (d) any combination of (a), (b) or (c); by paying 151 payable 131 equivalent amount, plus or minus, economic incentives to Party 130. Agent 150 under condition (a) and (b) above then holds the rights 152 to receivable 121 and upon payment by Party 110 on Payable 111, Agent 150 would receive the proceeds 153, plus or minus, any economic incentives. Chains can be of any lengths, amount or date ranges among other variables.

FIG. 3b is a continuation of FIG. 3a and a combination of Chains similar to FIG. 1 and FIG. 3a using an Agent 300 to facilitate the direct or indirect combination of separate Chains. Separate Chains can include any Chain where the first Party is three of more Parties removed from a recipient of payment in any Chain, whereas the payer and recipient can be, not exclusively, considered to be in separate Chains.

Some contemplated methods include that the Agent 300 pay 301 the payable 322 of Party 320 on its purchase invoice 322, according to the methods of FIG. 3a followed by offering and/or sharing economic incentives 306 offered by Party 370 with 307 Party 310, which is usually linked but not always to specific receivables and payables, for example receivable 371 and payable 311.

The economic incentives will be based on Business Rules and may include deadlines and amounts among other variables and conditions. Party 310 can decide to make cash payment 302 on payable 311, which will go to or through Agent 300 (see FIG. 3a for explanation) to pay 303, in part or in whole, payable 362 to Party 370. The Agent 300 intermediate such transaction because of owning or controlling the economic interest 308 in receivable 321 of Party 320 as explained in FIG. 3a. The Agent 300 is, in a similar fashion to FIG. 3a, provided funds or equivalent economic value to pay or offset payable 322 or provided funds or equivalent value to Party 320 in return for economic interest 308 in receivable 321. Other methods may include combinations of the above with multiple Chains and Parties.

### EXAMPLES

An employee of a public or private organization can use his/her earned or to be earned compensation to pay a mortgage payment on a weekly basis rather than monthly to save a considerable amount on interest and reduce total mortgage obligation. The Chain is the employee's employer, the employee and the mortgage holder. Another form is for employee to receive credit today to make the mortgage payment based on transferring the compensation he/she will receive in the future to the Party providing the credit. Achieving the same objective by introducing one more Party to the Chain.

Another example is a business getting liquidity to make payroll and payments due to third Parties. The business can use its sales invoices as a seller to satisfy, in part or in whole, purchase invoices as customer of another seller.

1. An economic value exchange and invoice resolution system, comprising:
at least one sales invoice, wherein each sales invoice comprises a credit value,
at least one purchase invoice, wherein each purchase invoice comprises a debit value,
at least one database or repository stored on a medium for executing the executable code that collects the information for the at least one sales invoice and the at least one purchase invoice;

2. An economic value exchange and resolution system, comprising:
at least one sales invoice, wherein each sales invoice comprises a credit value,
at least one purchase invoice, wherein each purchase invoice comprises a debit value,
at least one database or repository stored on a medium for executing the executable code that collects the information for the at least one sales invoice and the at least one purchase invoice; and
an executable code for intelligently determining an invoice Chain comprising at least one purchase invoice having a debit value and at least one sales invoice having a credit value and offsetting the debit value with the credit value to form an offset value.

3. The system of claim 1, wherein the medium for executing the executable code comprises a computer processor, a server system, a network system, a web-based system, the internet or a combination thereof.

4. The system of claim 1, wherein an Agent is linking one or more invoice chains.

5. The system of claim 1, wherein an Agent is purchasing and selling sales and or purchase invoices;

6. The system of claim 1, wherein economic incentives are provided.

7. The system of claim 1, wherein economic incentives are exchanged between two or more separate invoice Chains linked together by an Agent, without an Agent or a combination thereof.

8. The system of claim 1, wherein an executable code is used to determine economic incentives.

9. The system of claim 1, wherein the invoice Chain is a complete Chain.

10. The system of claim 1, wherein no database or repository is used.

11. The system of claim 1, wherein the invoice Chain is a disparity or incomplete Chain.

12. The system of claim 1, wherein a sales invoice is any credit value on any obligation.

13. The system of claim 1, wherein a purchase invoice is any debit value on any obligation.

14. The system of claim 1, wherein at least one determined optimal condition is utilized to determine an optimal starting point for the invoice Chain.

15. The system of claim 1, wherein the invoice Chain comprises an optimal invoice Chain.

16. The system of claim 1, wherein economic value is automatically determined.

17. The system of claim 1, wherein at least one of the at least one sales invoice is provided by a seller, a customer or a combination thereof.

18. The system of claim 1, wherein only information is received, sent or exchanged without offsetting, purchasing or selling any sales invoice.

19. The system of claim 1, wherein only information is received, sent or exchanged without offsetting, purchasing or selling any purchase invoice.

20. The system of claim 1, wherein at least one of the at least one purchase invoice is provided by a customer.

21. The system of claim 1, wherein the offset value is zero.

22. The system of claim 1, wherein the offset value is greater than zero.

23. The system of claim 1, wherein the offset value is less than zero.
